(19) United States
(12) Patent Application Publication
(10) Pub. No.: US 2017/0292636 A1
(43) Pub. Date: Oct. 12, 2017

(54) CONDUIT CLAMP SYSTEM

(71) Applicant: Dominion Energy, Inc., Richmond, VA (US)

(72) Inventor: Kenneth M. Sykes, Richmond, VA (US)

(21) Appl. No.: 15/634,431

(22) Filed: Jun. 27, 2017

Related U.S. Application Data
(63) Continuation of application No. 13/869,596, filed on Apr. 24, 2013.
(60) Provisional application No. 61/639,271, filed on Apr. 27, 2012.

(51) Int. Cl. F16L 5/10

(52) U.S. Cl. CPC F16L 5/10

(57) ABSTRACT

Conduit clamp fittings that provide a seal for a conduit extending through an enclosure wall, where the clamp includes first and second pieces configured to connect to each other. The first and second pieces may each include a shaft surface formed thereon and configured to encircle a portion of the conduit near the enclosure wall. Methods and equipment employing such clamps are also described.

### CLAIM OF PRIORITY

This application is a continuation of U.S. patent application Ser. No. 13/869,596, filed Apr. 24, 2013, which claims priority under 35 U.S.C. §119(e) to U.S. provisional patent application 61/639,271 filed on Apr. 27, 2012, which are each hereby incorporated by reference in their entirety herein.

### BACKGROUND

Described embodiments relate generally to the field of connectors, and more particularly to the connection of a conduit to an enclosure.

Connections between electrical conduits and enclosures, such as an electrical box, are typically secured using a locknut. As shown in FIG. 1, a conduit 10, such as a rigid metal wireway typically containing one or more wires or tubes for an electrical connection, gaseous connection, optical connection, or other type of connection to elements within an enclosure 11, passes through an aperture 13 provided in the enclosure wall 12. A first standard locknut 14 screws into a position on an exterior of enclosure wall 12, and a second locknut 16 screws into a position on an interior of enclosure wall 12. The standard locknuts 14, 16 typically screw into position along threads 15 provided on the conduit 10.

It is desirable to form a seal of the aperture 13 where the conduit 10 extends through the enclosure wall 12. For example, in a combustible dust area, a fire or explosion may occur if dust permeates the enclosure of a piece of electrical equipment. The Occupational Safety and Health Administration (OSHA) has specified Occupational Safety and Health Standard No. 1910.269. Subpart V, section XII of this standard has been adopted by all electrical utilities. This standard requires all coal handling portions of a power plant to comply with NFPA 70 (National Electric Code), Article 502, which in turn requires all equipment in combustible dust areas to be dust-tight (i.e., to be sealed from entry of dust into the equipment). In addition, other elements, such as water, gases, or liquids, can be harmful if they penetrate the enclosure of a piece of equipment. It is desirable to makes the conduit connection dust-tight against the hazards of a Class II Div. 2 environment. It is desirable to provide an IP-66 certified seal, meaning that the conduit connection will be dust-tight and water spray resistant.

Standard locknuts, such as those often used to provide conduit connections in equipment in combustible dust areas, are not sealed in a dust-tight manner. In order to comply with the Articles discussed above, these standard locknuts need to be retrofitted with a dust-tight seal. However, conventional practices of retrofitting standard locknuts with a dust-tight seal are expensive and time consuming. For example, one conventional method for providing a dust-tight conduit connection is by using a myers hub. A myers hub, however, is typically used for a new installation, and if it is used in a retrofit application, all wires in an enclosure must be disconnected and pulled back to the closest pull box, the conduit must be disassembled and cut, the conduit threading must be retapped, the myers hub must be attached, and all wires must then be reconnected. This process must be repeated for every piece of conduit entering the enclosure. Depending on the number of conduits in an enclosure it could take a two-man crew several days to retrofit a single enclosure.

Accordingly, there is a desire for devices and methods that provide a quick and certifiable way of retrofitting connections to form the desired seal for an enclosure.

### SUMMARY

Described embodiments include structures and methods for fastening conduit connections that include a two-piece clamp designed to encompass a standard locknut on the exterior surface of the enclosure wall, and to provide a seal at the conduit connection. The described embodiments permit attachment without requiring disconnecting of wires or modification of the conduits, wireways, or enclosure. Using the clamps described herein provides a fast and cost-effective way of sealing standard locknuts. In one aspect the described embodiments provide a two piece fitting with flanged gasket at the enclosure and compression gasket between the fittings.

### BRIEF DESCRIPTION OF THE DRAWINGS

FIG. 1 is a schematic diagram of a conventional conduit connection to an enclosure.

FIG. 2 is a view of a clamp, in accordance with embodiments described herein.

FIG. 3 is a schematic diagram of a conduit connection to an enclosure, in accordance with embodiments described herein.

FIG. 4 is a perspective inside view of one piece of a two-piece clamp, in accordance with embodiments described herein.

FIG. 5 is an inside side view of the piece of FIG. 4.

FIG. 6 is a top view of the piece of FIG. 4.

FIG. 7 is a view like FIG. 4, showing gasket placement.

FIGS. 8A-8B are top views of the gasket pieces for FIG. 7.

FIG. 9 is a perspective inside view of one piece of a two-piece clamp, in accordance with another embodiment described herein.

FIG. 10 is a schematic diagram of an enclosure with conduit clamps in accordance with embodiments described herein.

FIG. 11 is a perspective inside view of a two-piece clamp, in accordance with yet another embodiment described herein.

FIG. 12 is a view like FIG. 11, showing gasket placement.

FIG. 13 is a perspective inside view of the flange of one piece of the clamp of FIG. 12.

### DETAILED DESCRIPTION OF PREFERRED EMBODIMENTS

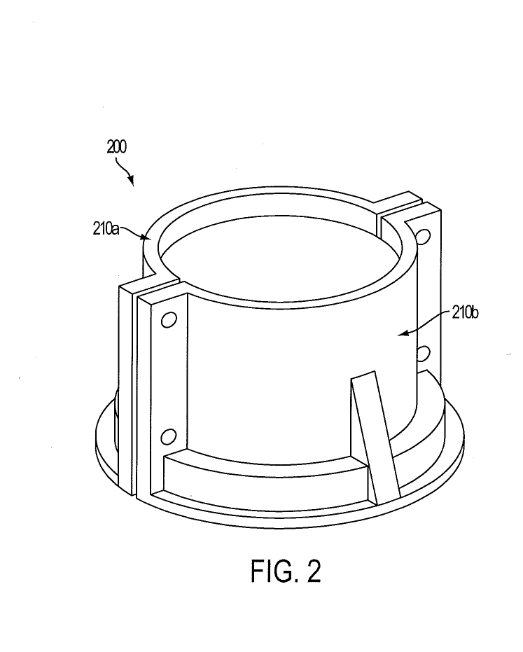

FIG. 2 shows a diagram of a conduit clamp 200 for an enclosure. Clamp 200 is a two-piece fitting with flanged gasket at the enclosure and compression gasket between the fittings. Clamp 200 includes a first fitting piece 210a and a second fitting piece 210b. The clamp 200 can be formed, for example, from a die-casted Zinc #3 alloy. The clamp 200 can be designed to correspond to standard conduit sizes, such as one of eight standard sizes including 0.5″, 0.75″, 1″, 1.25″, 1.5″, 2″, 2.5″, and 3″.

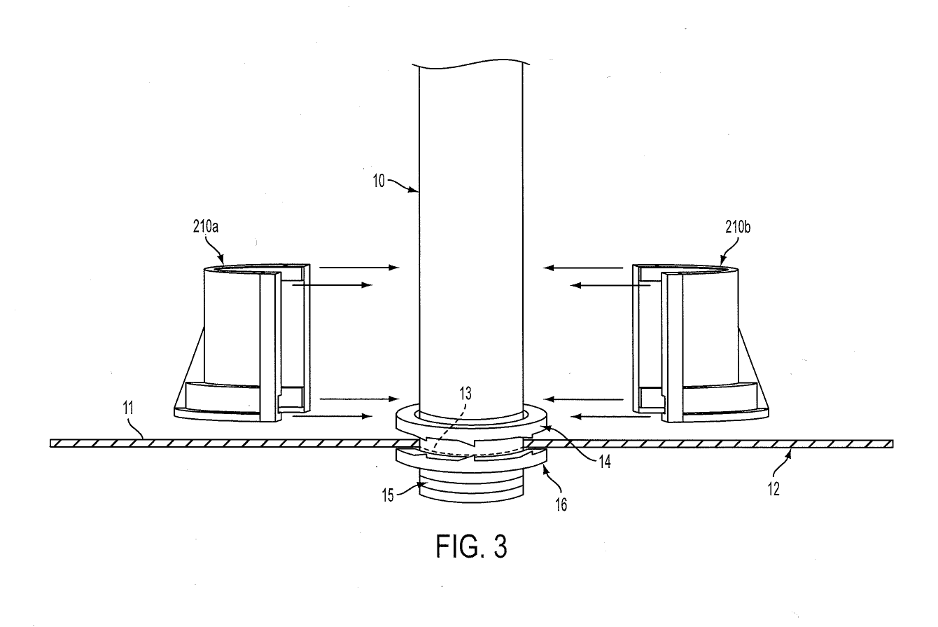

FIG. 3 shows a diagram of a conduit connection to an enclosure 11 including the pieces 210a, 210b of the clamp 200. An existing conduit connection to which the clamp 200 may be applied may include, for example, a conduit 10, such as a rigid metal wireway typically containing one or more wires or tubes for an electrical connection, gaseous connection, optical connection, or other type of connection to elements within an enclosure 11. The conduit 10 traverses the enclosure wall 12 at aperture 13. Conventional locknuts 14, 16 screw into respective positions above and below the enclosure wall 12, typically along threads 15 provided on the conduit 10.

As shown in FIG. 3, the clamp 200 is designed to retrofit the existing conduit connection to form a seal. Pieces 210a and 210b of clamp 200 connect on respective sides of conduit 10 to form the seal. The clamp 200 is configured to engulf the standard locknut 14 at the exterior surface of the enclosure wall 12 to provide the seal, without requiring disconnection of wires within the enclosure 11 or significant modification the existing conduit connection. Using the clamp 200 provides a time saving and cost effective way of sealing standard locknuts in a combustible dust environment.

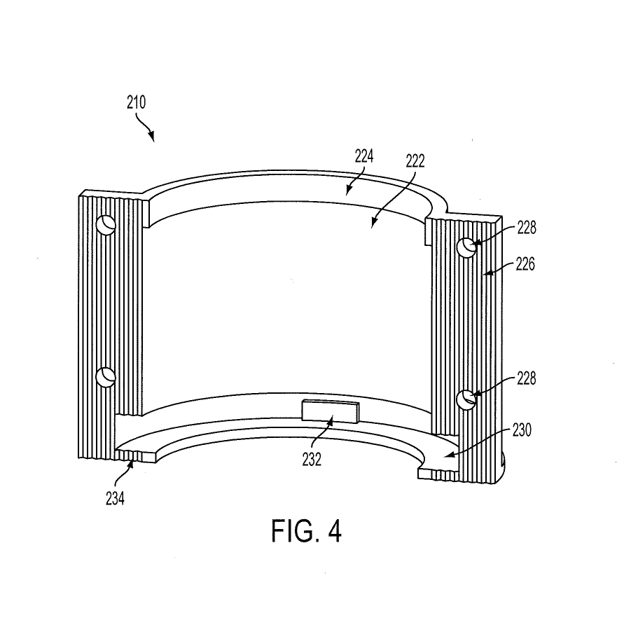

FIG. 4 shows one piece 210 of a two-piece clamp 200 (FIG. 2). For purposes of clarity, only a single fitting piece 210 is shown in FIG. 4. It should be understood, however, that described characteristics of piece 210 may be included on one or both of pieces 210a, 210b (FIG. 2).

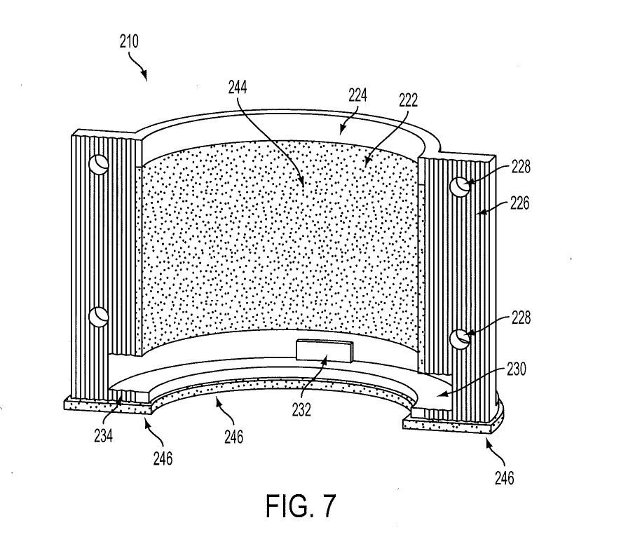

Clamp 200 includes a shaft 222, which is the area of the clamp 200 that runs perpendicular with the conduit 10 (FIG. 3), above a cavity 230 and below a cap 224 (described further below). Shaft 222 is configured to allow ample area for a shaft gasket 244 (FIG. 7) to seal the wireway of enclosure 11 (FIG. 3) through which conduit 10 traverses from dust and water entering from the vertical direction. The inner circumference of the shaft 222 may be slightly larger than the maximum outer diameter of the desired conduit 10 to which clamp 200 is to be connected, in order to allow room for the shaft gasket 244 (FIG. 7).

Clamp 200 includes an inwardly projecting and circumferentially extending cap 224 located at the top of clamp 200. The inner circumference of the cap 224 is about the same dimension as the maximum outer diameter of the conduit 10, and overhangs the area for the shaft gasket 244. The cap 224 provides a barrier to aid in positioning the gasket 244 and to protect the shaft gasket 244 (FIG. 7) from direct exposure to dust and water.

Each piece 210 of clamp 200 includes a flange 226 on each side. The flanges 226 define the primary area of the clamp 200 where the two pieces 210a, 210b (FIG. 2) meet. In one embodiment, each flange 226 may include a flat surface corresponding to a respective flat surface on a corresponding flange 226 of the opposite piece. The flanges 226 are an area of concern for dust and water infiltration. Accordingly, in another embodiment, the flanges 226 may be designed with grooves on their respective surfaces. Each groove peak on each flange 226 is configured to mate with a corresponding groove valley of the flange 226 on the opposite piece of the clamp 200. For example, each flange 226 may include seven groove peaks and seven groove valleys surrounding the shaft 222, and five groove peaks and five groove valleys surrounding the locknut cavity 230. A jagged seam is created by the corresponding groove peaks and valleys, providing a tortuous path seal or gasket to inhibit dust from passing through.

Each flange 226 contains two holes 228 for receiving respective screws. In some embodiments, one piece (e.g., piece 210a) of the clamp 200 includes flanges 226 with threaded holes 228, while the other piece (e.g., piece 210b) includes flanges with untapped holes 228. Holes 228 can be configured to receive four screws to attach the two pieces 210a, 210b of the clamp 200 around the conduit 10. Tightening the screws creates a compression gasket between the fittings by compressing the two fittings 210a and 210b together at flanges 226, and/or by compressing shaft gaskets 244.

Clamp 200 includes a locknut cavity 230, which is configured to enclose a standard locknut 14 on the exterior of enclosure wall 12 (FIG. 3) when the pieces 210a, 210b of clamp 200 are assembled. The locknut cavity 230 is formed by a groove between the shaft 224 and a lip 234 of the clamp 200.

The locknut cavity 230 may include a notch 232. The contour of the notch 232 follows a circumference of a standard locknut 14, and is designed to extend at least part of the distance between the teeth of the standard locknut. The notch 232 is an inward protrusion located in the locknut cavity 230. The notch 232 may only be included on one piece of the clamp 200 (e.g., piece 210a or piece 210b), or may be included in both pieces 210a and 210b. The notch 232 is configured to mate against a standard locknut 14 (FIG. 3) when the clamp 200 is assembled. With such a configuration, the clamp 200 can be twisted such that the notch 232 will push the teeth of the standard locknut 14, causing the standard locknut 14 to turn. The threaded connection between the conduit 10 and the standard locknut 14 will force the standard locknut 14 to press against the clamp 200, compressing a lip gasket 246 (described further below) to create a seal against enclosure wall 12.

The clamp 200 includes a lip 234 that forms the bottom portion of the clamp 200. Lip 234 may be the thinnest portion of the piece 210, in order to fit between the bottom surface of a standard locknut 14 and above the enclosure wall 12 (FIG. 3). The lip 234 may also be the widest part of the clamp 200, in order to maximize surface area of the seal. The lip 234, along with one or more gaskets, provides a flanged gasket at the enclosure.

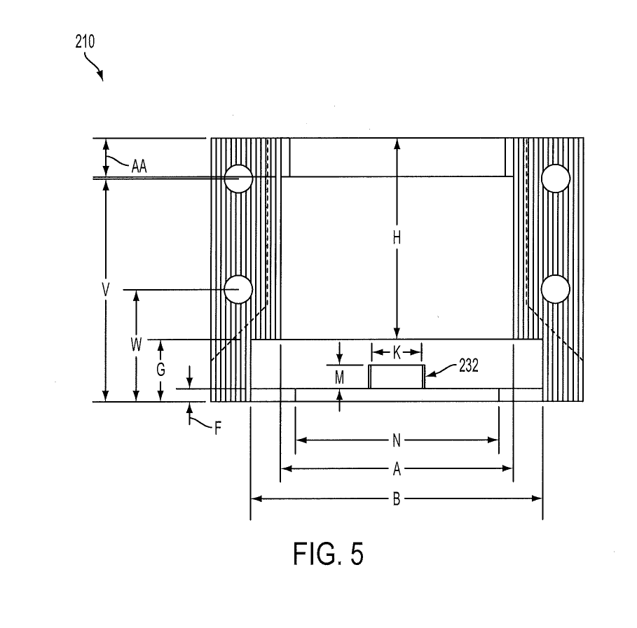

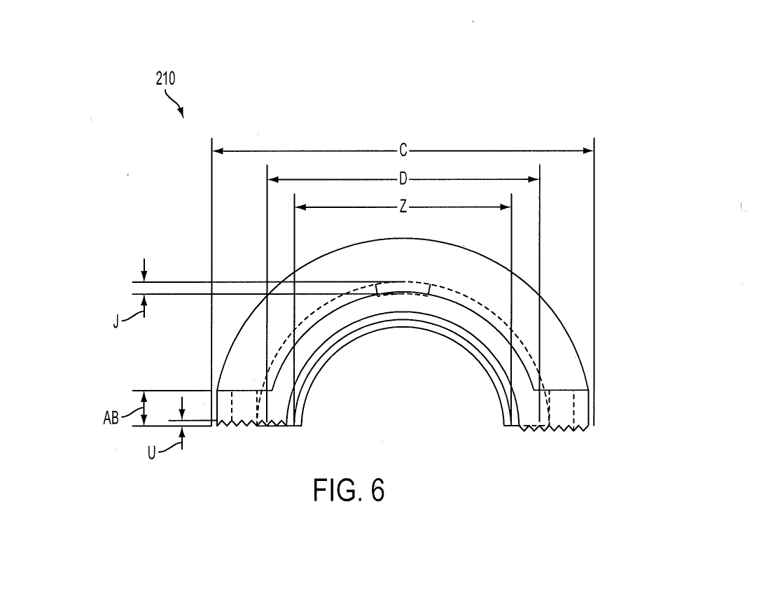

FIGS. 5 and 6 show a cross-sectional diagram and a top-down diagram, respectively, of one piece 210 of the clamp 200. In one embodiment of the clamp 200, the piece 210 may include the following dimensions, as identified in FIGS. 5 and 6:

| | | Standard English Conduit Sizes | | | | | | | |
|---|---|---|---|---|---|---|---|---|---|
| | Part Description | ½″ | ¾″ | 1″ | 1.25″ | 1.5″ | 2″ | 2.5″ | 3″ |
| A. | Upper Diameter | 0.907 | 1.118 | 1.383 | 1.728 | 1.968 | 2.451 | 2.956 | 3.587 |
| B. | Encompass Diameter | 1.1875 | 1.438 | 1.75 | 2.219 | 2.5625 | 3.0625 | 3.625 | 4.25 |
| C. | Lower Outside Diameter | 1.6255 | 1.875 | 2.25 | 2.625 | 2.9375 | 3.4375 | 4 | 4.6875 |
| D. | Outside Upper Diameter | 1.095 | 1.306 | 1.571 | 1.916 | 2.156 | 2.639 | 3.144 | 3.775 |
| F. | Lip Thickness | 0.0625 | 0.0625 | 0.0625 | 0.0625 | 0.0625 | 0.0625 | 0.0625 | 0.0625 |
| G. | Encompass Height | 0.3625 | 0.3725 | 0.3925 | 0.4925 | 0.4925 | 0.5425 | 0.6025 | 0.6025 |
| H. | Gasket Shaft Height | 1 | 1 | 1.5 | 1.5 | 1.5 | 1.5 | 2 | 2 |
| J. | Notch Depth | 0.0625 | 0.0625 | 0.0625 | 0.0625 | 0.0625 | 0.0625 | 0.0625 | 0.0625 |
| K. | Notch Length | 0.125 | 0.25 | 0.25 | 0.25 | 0.25 | 0.375 | 0.375 | 0.375 |
| M. | Notch Height | 0.125 | 0.125 | 0.125 | 0.125 | 0.125 | 0.125 | 0.125 | 0.1875 |
| N. | Lip Diameter | 0.365 | 1.076 | 1.341 | 1.686 | 1.926 | 2.409 | 2.914 | 3.545 |
| R. | Upper Threading # | 4.131 | 4.353 | 4.985 | 5.158 | 5.575 | 5.672 | 6.003 | 6.328 |
| T. | Lower Threading # | 5.037 | 5.031 | 5.750 | 4.669 | 4.313 | 4.313 | 4.313 | 5.031 |
| V. | Upper Screw Hole Height | 1.183 | 1.175 | 1.692 | 1.807 | 1.762 | 1.812 | 2.373 | 2.373 |
| W. | Lower Screw Hole Height | 0.578 | 0.625 | 0.645 | 0.745 | 0.791 | 0.841 | 0.901 | 0.901 |
| X. | Screw Size | #6-32 | #6-32 | #6-32 | #6-32 | #10-24 | #10-24 | #10-24 | #10-24 |
| XA. | Hole Dia. (Formed Threads) | 0.118 | 0.118 | 0.118 | 0.118 | 0.165 | 0.165 | 0.165 | 0.165 |
| XB. | Hole Dia./Screw Clearance | 0.157 | 0.157 | 0.157 | 0.157 | 0.204 | 0.204 | 0.204 | 0.204 |
| Y. | Groove Depth | 0.026 | 0.026 | 0.026 | 0.026 | 0.026 | 0.026 | 0.026 | 0.026 |
| Z. | Cap | 0.855 | 1.066 | 1.331 | 1.676 | 1.916 | 2.399 | 2.904 | 3.535 |
| AA. | Cap Depth | 0.1875 | 0.1875 | 0.1875 | 0.1875 | 0.1875 | 0.1875 | 0.1875 | 0.1875 |
| AB. | Flange Thickness | 0.1875 | 0.1875 | 0.1875 | 0.1875 | 0.1875 | 0.1875 | 0.25 | 0.25 |
| AC. | Screw Length | 0.75 | 0.75 | 0.75 | 0.75 | 0.75 | 0.75 | 0.75 | 0.75 |

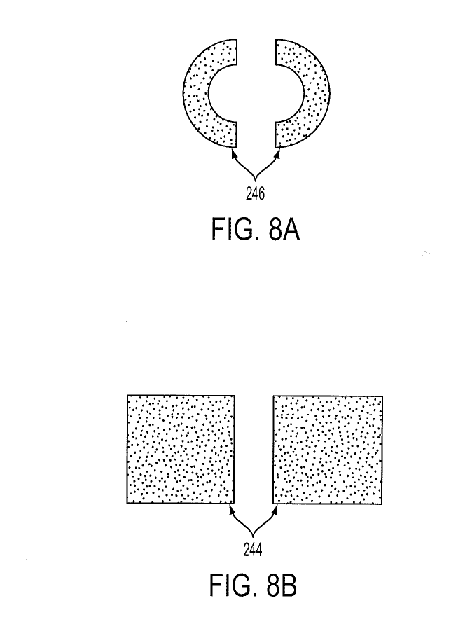

FIG. 7 shows a piece 210 of a clamp 200 with a shaft gasket 244, and a lip gasket 246 positioned at the piece 210. FIGS. 8A-8B show the lip gaskets 246 and shaft gaskets 244, respectively, separate from the piece 210. Each gasket 244, 246 may be formed from a flexible protective material, such a foam neoprene.

The shaft gasket 244 is configured to be positioned at a shaft 222 in a clamp piece (e.g., piece 210a or piece 210b), to provide a seal along the circumference of the conduit 10 (FIG. 3) when pieces 210a and 210b are attached. As shown in FIG. 8B, a separate shaft gasket 244 may be provided for each piece (e.g., piece 210a and piece 210b) of the clamp 200. Each shaft gasket 244 may be sized for the circumference of the inner diameter of the section 210, such that when the pieces 210a and 210b of the clamp 200 are assembled, the two shaft gaskets 244 will wrap entirely around the conduit 10, to ensure a complete seal around the conduit.

The lip gasket 246 is configured to be positioned at the bottom surface of the lip 234 of the clamp 200, in order to seal water and dust from infiltrating between the clamp 200 and the enclosure wall 12. As shown in FIG. 8A, a separate lip gasket 246 may be provided for each piece (e.g., piece 210a and piece 210b) of the clamp 200. The width of the lip gasket 246 may be sized for the width of the lip 234, such that the lip gasket 246 extends over the circumference of the lip 234 of the clamp 200. When the pieces 210a, 210b of clamp 200 are assembled, the lip gaskets 246 extend to create a circular shaped compression seal. When the clamp 200 is installed on a conduit 10 traversing an enclosure wall 12 (FIG. 3), the respective portions of each lip gasket 246 extending over the lip 234 are compressed towards the opening in the enclosure wall 12, providing a seal around the conduit 10 from the locknut cavity 230.

A method for attaching a clamp 200 to an enclosure 11 in accordance with one or more embodiments described herein is described with reference to elements in FIGS. 3, 4, and 7. First, in the case of an electrical enclosure, power to the enclosure should be isolated. Once power to the enclosure is isolated, the enclosure can be opened.

Next, the standard locknut 14 on the exterior surface of the enclosure wall 12 is unscrewed at least two rotations. If the locknut 14 on the exterior surface cannot be unscrewed by at least two rotations, the locknut 16 on the interior surface of the enclosure wall 12 may need to be unscrewed a few rotations to achieve an adequate gap between the exterior surface of the enclosure wall 12 and the exterior standard locknut 14.

In an embodiment including shaft gaskets 244, the piece (e.g., piece 210a) including the shaft gasket 244 is then placed against the conduit 10 resting on the exterior of the enclosure wall 12. The opposite piece (e.g., piece 210b) including a shaft gasket 244 is then placed against the conduit 10, with the respective flanges 226 of the pieces 210a, 210b in contact with one another. The standard locknut 14 should be located within the locknut cavity 230, and the notch 232 should be aligned between the teeth of the standard locknut 14.

Next, screws (not shown) are inserted through each of the holes 228. Holes 228 should align in the corresponding flanges 226 of the opposing pieces 210a, 210b. The screws should be inserted into the piece including unthreaded holes 228 and towards the piece including threaded holes 228. The inserted screws are then partially tightened one screw at a time, alternating between screws to ensure all four screws are tightened equal amounts so binding does not occur. The screws of the clamp 200 are tightened in this manner until all of the screws are hand tight.

The conduit connection may then be tightened from the interior of the enclosure 11, if necessary, by tightening the standard locknut 16 on the interior side of the enclosure wall 12.

The clamp 200 may be twisted prior to tightening the screws in holes 228. Once the screws of clamp 200 are tightened, however, further twisting the clamp may reposition one or more of the gaskets 242, 244, 246 and break the seal.

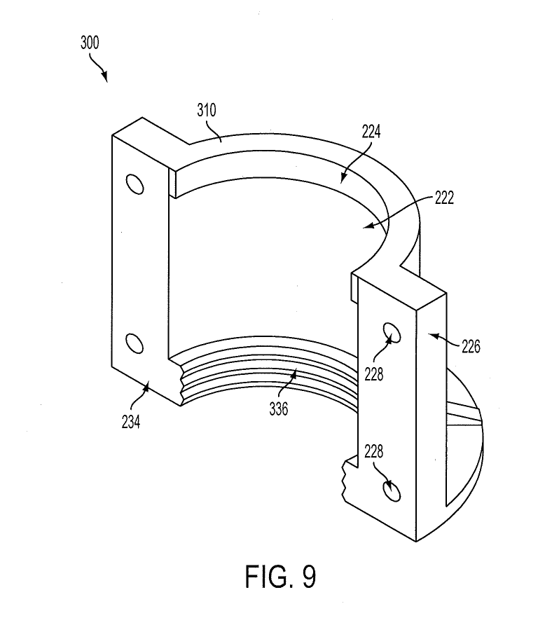

FIG. 9 shows a clamp fitting piece 310 of a conduit clamp 300, in accordance with another embodiment. Clamp 300 is a two-piece threaded fitting with flanged gasket at the enclosure and compression gasket between the fittings. Piece 310 includes a shaft 222, cap 224, flange 226, holes 228, and lip 234, with similar features to those described above in connection with FIGS. 2-8. Instead of a cavity 230 described in connection with FIG. 4, piece 310 includes threads 336 between lip 234 and shaft 222, which are configured to interface with the threads of a conduit 10 (FIG. 3).

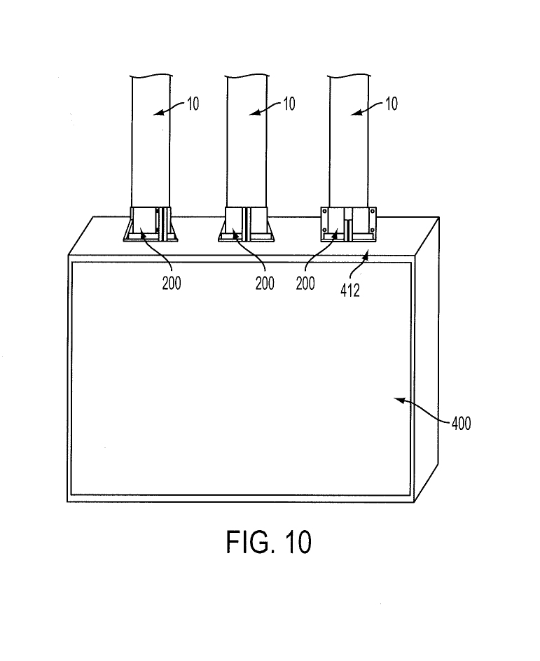

FIG. 10 shows a diagram of an enclosure 400 including multiple conduit connections with clamps 200. Enclosure 400 may be, for example, an electrical box, with multiple electrical conduits 10 traversing an exterior wall 412 of the enclosure 400.

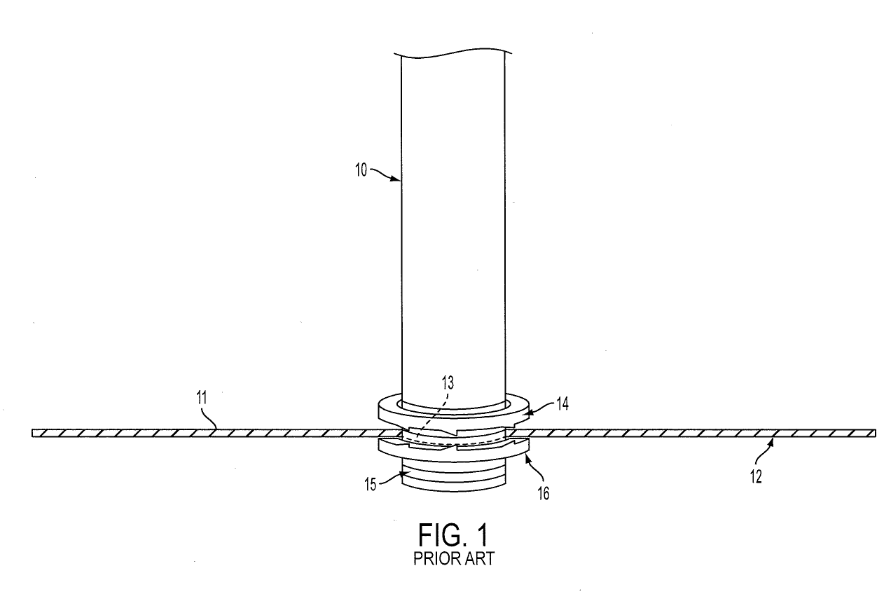

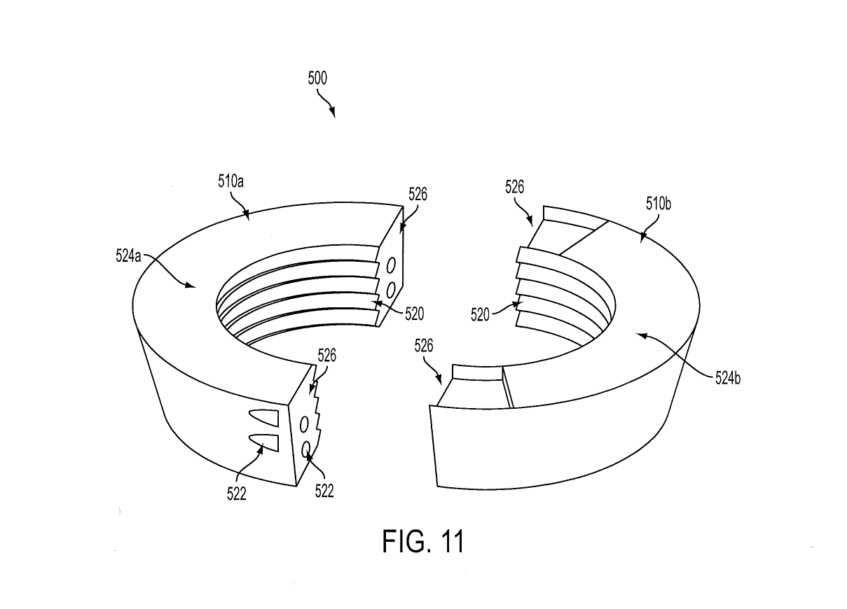

FIG. 11 shows a diagram of another embodiment of a conduit clamp fitting 500. The clamp 500 in FIG. 11 is a two-piece threaded fitting with flanged gasket at the enclosure and compression gasket between the fittings. The clamp 500 includes a first fitting piece 510a and a second fitting piece 510b. Each piece 510a, 510b of the clamp 500 is proportional to the opposite piece. Pieces 510a, 510b include respective flanges 526, which are configured to contact one another when pieces 510a, 510b are connected. When pieces 510a and 510b are connected, the clamp 500 is a truncated cone-shaped threaded device. The two-piece clamp 500 may have surfaces or other features (not shown) formed in it for engagement by a tool or hand for turning the clamp 500 on the conduit threads. The taper of the cone may be approximately a one-to-three ratio of the standard locknut diameter. In such a case, the surface of the clamp 500 against the enclosure wall 12 (FIG. 1) formed by surfaces 524a and 524b of pieces 510a, 510b, respectively, will be three times wider than the standard locknut thickness, and the other surface will be equal to approximately the diameter of a standard locknut ratio. A wider surface area against an enclosure wall 12 will help protect the enclosure from dust exposure.

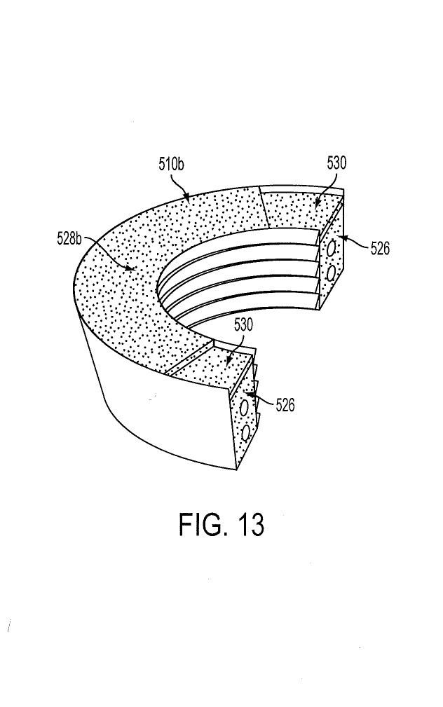

The inner surface area of each piece 510a, 510b includes threads 520 that are configured to align when pieces 510a, 510b are attached, and sized to engage the conduit threads 15. Piece 510a of clamp 500 is a male piece, and piece 510b of clamp 500 is a female piece. Four Allen screws can be inserted into screw holes 522 on the exterior of the male piece 510a of the clamp 500. The screw holes 522 are configured to traverse through the flanges 526 of the male piece 510, and correspond to screw holes (shown in FIG. 13) in the female piece 510b of the clamp 500. The screw holes 522 may include metric machine screw threading.

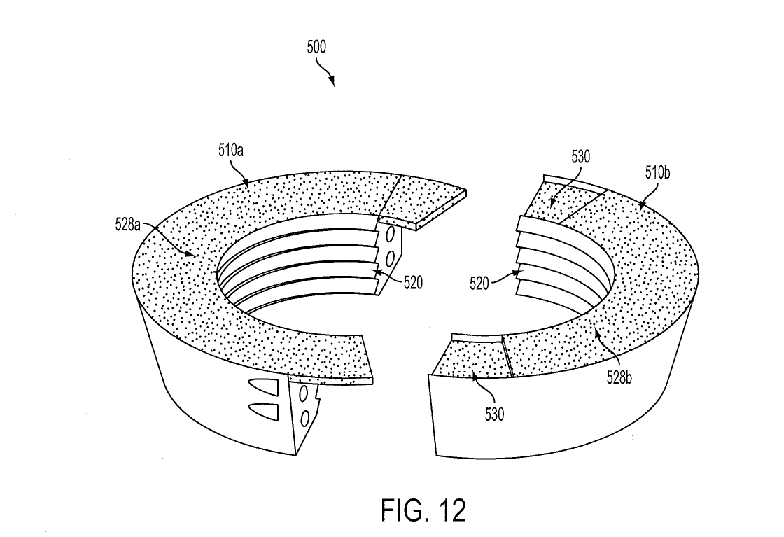

As shown in FIG. 12, the clamp 500 may include one or more gaskets 528a, 528b located at seams and enclosure pressure points. The male piece 510a may include a continuous gasket 528a, which extends across the surface 524a (FIG. 11) that resides against the enclosure wall 12. The female piece 510b may have a continuous gasket 528b, which extends across the surface 524b (FIG. 11) that resides against the enclosure surface 12. The female piece 510b also includes a depressed area 530 that will accept the gasket overlap of the male piece 510a.

As shown in FIG. 13, the gasket 528b of the female piece 510b may seamlessly extend onto the flange 526. The gasket 528b may include holes to accommodate screw holes in the female piece 510b. The gasket 528a of the male piece 510a, on the other hand, overlaps slightly beyond the surface 524a, but does not extend onto the flange 526. The overlap from the gasket 528a is configured to mate against an indented portion 530 of the female piece 510b to create a sealed connection when the surfaces 524a, 524b are compressed against an enclosure wall. The flanges 526a, 526b and corresponding gaskets 528a, 528b form a compression gasket between the male section 510a and the female section 510b, and the surfaces 524a, 524b and corresponding gaskets 528a, 528b form a flanged gasket at the enclosure wall.

When pieces 510a, 510b are attached and the respective gaskets 528a, 528b mated together, screws may be inserted into holes 522 to achieve proper compression to form a compression gasket between the fittings 510a and 510b. The threaded piece 520 will be twisted against the enclosure wall 12, creating a dust-tight connection replacing an existing standard locknut 14 (FIG. 1).

Example embodiments of methods, systems, and components thereof have been described herein. As noted elsewhere, these example embodiments have been described for illustrative purposes only, and are not limiting. Furthermore, certain processes are described, including the description of several steps. It should be understood that the steps need not be performed in the described order unless explicitly identified as such, and some steps described herein may not be performed at all. The breadth and scope of the present invention should not be limited by any of the above described exemplary embodiments, but should be defined only in accordance with the following claims and their equivalents.

What is claimed as new and desired to be protected by Letters Patent of the United States is:

1. A clamp system, the system comprising:
a threaded conduit extending through an enclosure wall;
a two-piece fitting clamp for providing a seal for the threaded conduit, the threaded conduit extending through the enclosure wall, the clamp including:
a first piece and a second piece, wherein the first piece is configured to connect to the second piece; and
a shaft surface formed on each of the first and second pieces, wherein the shaft surfaces are configured to encircle a portion of the conduit near the enclosure wall,
wherein, when the first piece and the second piece are connected around the threaded conduit, a first gasket is formed between the clamp and the enclosure wall and a second gasket is formed between the first and second pieces proximate where the first and second pieces are connected to each other.

2. The system of claim 1, further comprising a locknut cavity for encompassing a locknut threaded onto the conduit and

[symbol]

3. The system of claim 2, further comprising a lip forming a bottom portion of the locknut cavity, and wherein, when the first piece and the second piece are connected, the lip fits between the locknut threaded onto the conduit and the enclosure wall.

4. The clamp system of claim 2, further comprising a notch that extends inward into the locknut cavity, wherein the notch is configured to mate against the locknut threaded onto the conduit, when the first piece and the second piece are connected.

5. The clamp system of claim 1, wherein the first piece and the second piece each includes threaded surfaces for forming threads for engaging the conduit threads.

6. The clamp system of claim 1, wherein the second gasket is a compression gasket between the first and second pieces.

7. The clamp system of claim 1, further comprising corresponding grooves on respective surfaces of the first and second pieces between where the first and second pieces are connected together, wherein the grooves include a plurality of peaks and valleys and each grove peak is configured to mate with a corresponding groove valley on the respective surfaces of the first and second pieces.

8. The clamp system of claim 7, wherein the grooves include between 5 and 7, inclusive, peaks and/or valleys.

9. The clamp system of claim 1, further comprising a third gasket positioned between the shaft surface of each of the first and second pieces and the conduit.

10. The clamp system of claim 1, further comprising an inwardly projecting cap at a top of each of the first and second pieces, wherein, when the first piece and the second piece are connected, the inwardly projecting cap is circumferentially extending.

11. The clamp system of claim 1, wherein the first gasket is positioned on a bottom surface of each of the first and second pieces.

12. The clamp system of claim 11, wherein a width of the first gasket is such that the first gasket extends past an edge of an internal circumference of the bottom surface of each of the first and second pieces, and wherein, when the first and second pieces are connected together, the first gasket forms a circular compression seal and is compressed toward the opening in the enclosure wall.

13. The clamp system of claim 9, wherein the third gasket is foam neoprene.

14. The clamp system of claim 11, wherein the first gasket is foam neoprene.

15. The clamp system of claim 9, further comprising adhesive attaching the third gasket to the shaft surface of each of the first and second pieces.

16. The clamp system of claim 11, wherein the first gasket is a lip gasket, and the clamp further comprises adhesive attaching the lip gasket to the bottom surface of each of the first and second pieces.

17. A method of forming a seal for an existing conduit connection, wherein the conduit connection includes a threaded conduit extending through an enclosure wall, a first locknut engaging one side of the enclosure wall and a second locknut engaging the other side of the enclosure wall for affixing the conduit to the enclosure wall, the method comprising the steps of:
providing a two-piece fitting clamp with first gasket at the enclosure wall and a second gasket between first and second pieces of the clamp proximate where they are connected together for providing a seal for a threaded conduit extending through an enclosure wall, the clamp including a first piece and a second piece, wherein the first piece is configured to connect to the second piece and a shaft surface is formed on each of the first and second pieces, wherein the shaft surfaces are configured to encircle a portion of the conduit near the enclosure wall;
loosening the first locknut;
placing a shaft surface of the first piece against the conduit, such that the shaft surface of the first piece partially encircles the conduit;
placing a shaft surface of the second piece against the conduit, such that the shaft portions of the first and second pieces encircle the conduit; and
connecting the first and second pieces.

18. The method of claim 17, wherein the first locknut is an exterior side of the enclosure wall, and wherein the clamp includes a locknut cavity for encompassing the first locknut, and the first and second pieces are placed against the conduit such that the locknut cavity portion of the first piece and the locknut cavity portion of the second piece encompass the first locknut.

19. The method of claim 18, further including the step of turning the second locknut to clamp the conduit to the enclosure wall, wherein the second locknut is on an interior side of the enclosure wall.

20. The method of claim 17, wherein the first piece and the second piece each includes threaded surfaces for forming threads for engaging the conduit threads.

21. The method of claim 20, further including the step of turning the assembled clamp to clamp the conduit to the enclosure wall.
